(19) United States
(12) Patent Application Publication
(10) Pub. No.: US 2016/0096255 A1
(43) Pub. Date: Apr. 7, 2016

(54) Wrench apparatus

(71) Applicant: Nigel Buchanan, New Gilston (GB)

(72) Inventor: Nigel Buchanan, New Gilston (GB)

(21) Appl. No.: 14/756,310

(22) Filed: Aug. 25, 2015

Related U.S. Application Data
(60) Provisional application No. 62/070,387, filed on Aug. 25, 2014.

(51) Int. Cl. B25B 13/14; B25B 13/20

(52) U.S. Cl. CPC B25B 13/14; B25B 13/20

(57) ABSTRACT

The present invention provides for a wrench tool comprising a slide lock mechanism including plates, rollers and a movable contact element.

### RELATED APPLICATION

This application is related to U.S. Patent Provisional Application Ser. No. 62/070,387 filed on Aug. 25, 2014 entitled “Wrench Apparatus”.

### BACKGROUND OF THE INVENTION

### Field of the Invention

This invention relates to a tool and more specifically, to a wrench apparatus with a slide lock mechanism.

### SUMMARY OF THE INVENTION

In one embodiment, the present invention provides for a wrench comprising: an elongated body having opposing ends, the first end comprises a head with an opening and the second end forming a handle, and the body comprising a recess situated adjacent the head, the recess having at least one back surface and at least two opposing walls; and a slide lock mechanism comprising at least one lock plate, at least one release plate and at least two rollers, each of the lock and release plates comprising at least on spring holding compartment, at least one central opening and at least two cutouts, each cutout consists of an opening, side walls, and an angled locking surface, and the mechanism has a contact element, at least a portion of the contact element contacting at least a portion of the lock plate, and the lock plate is situated above the release plate and the openings and cutouts of each of the plates are aligned with one another and inserted with the recess of the body. The mechanism further comprises at least two rollers and at least one spring, at least a portion of each of the rollers are situated within the cutouts of the plates, at least a portion of the spring is situated within the spring holding compartment of the plates, and the spring causes the rollers to engage the opposing walls of the recess of the body. The mechanism further comprises at least one button having a top contact surface and a bottom protrusion, at least a portion of said protrusion is designed to be situated within the central openings of the release and lock plates, whereby the slide lock mechanism functions based on movement of the button, and the button has two positions, a first operating position and a second non-operating position, when the button is in a non-operating position the rollers are urged against the angled locking surface of the cutouts thereby wedging the rollers against the sidewalls of the recess preventing the contact element from moving towards the handle.

In another embodiment, the button is moved toward the head thereby allowing movement of the contact element to move upwards within the opening of the head and change the width of the opening on the head and wherein the button is moved toward the handle thereby allowing the rollers to reduce locking contact with the opposing walls of the recess of the body and reduce locking contact with angled locking surface of the cutouts thereby allowing the contact element to adjust the width of the opening on the head.

In yet another embodiment, the movement of the button towards the head decreases the width of the opening on the head. In still another embodiment, the movement of the button towards the handle increases the width of the opening on the head.

In still another embodiment, the wrench further comprises at least one face plate, the face plate has a slit designed to receive a portion of the button, and the face plate designed to cover the recess of said body. In still yet another embodiment, the protrusion of the button is wedge shaped.

In a further embodiment, the wrench further comprises a second lock plate, the second lock plate comprising at least on spring holding compartment, at least one central opening and at least two cutouts. In another further embodiment, the second lock plate is situated below the release plate and the spring holding compartments, the central opening and the cutouts are aligned relative to the two lock plates and the release plate. In yet another further embodiment, the release plate is sandwiched between the two lock plates.

In still another further embodiment, the opposing walls have an enhanced gripping surface. In still yet another further embodiment, the back surface of the recess is formed by a second cover plate.

In another embodiment, the angled locking surface of the cutouts has an enhanced gripping surface. In yet another embodiment, the sidewalls of the recess are made of an insert of hardened metal.

In still another embodiment, the present invention relates to a slide lock mechanism designed to work with a tool, and the tool comprises a body with a recess and a head with an opening and a handle, and the mechanism comprises: at least one lock plate, at least one release plate and at least two rollers, each of the lock and release plates comprising at least one spring holding compartment, at least one central opening and at least two cutouts, and the mechanism having a contact element, at least a portion of the contact element contacting a portion of the lock plate, the lock plate is situated above the release plate and the openings and cutouts of each of the plates are aligned with one another and inserted with the recess of the body, the mechanism further comprising at least two rollers and at least one spring, at least a portion of each of the rollers are situated within the cutouts of the plates, at least a portion of the spring is situated within the spring holding compartment of the plates, the spring causes the rollers to engage the opposing walls of the recess of the body, the mechanism further comprises at least one button having a top contact surface and a bottom protrusion, at least a portion of the protrusion is designed to be situated within the central openings of the release and lock plates, whereby the slide lock mechanism functions based on movement of the button, the button has two positions, a first operating position and a second non-operating position, when the button is in a non-operating position the rollers are urged against the angled locking surface of the cutouts thereby wedging the rollers against the sidewalls of the recess preventing the contact element from moving towards the handle.

In a further embodiment, the present invention provides for a slide lock mechanism designed to work with a toll, the tool comprising a body with a recess and a head with an opening and a handle, the mechanism comprising: at least one lock plate, at least one release plate and at least two rollers, each of the lock and release plates comprising at least one spring holding compartment, at least one central opening and at least two cutouts, the lock plate having a contact element, the lock plate is situated above the release plate and the openings and cutouts of each of the plates are aligned with one another and inserted with the recess of the body, the mechanism further comprising at least two rollers and at least one spring, at least a portion of each of the rollers are situated within the cutouts of the plates, at least a portion of the spring is situated within the spring holding compartment of the plates, the spring causes the rollers to engage the opposing walls of the recess of the body, the mechanism further comprises at least one button having a top contact surface and a bottom protrusion, at least a portion of the protrusion is designed to be situated within the central openings of the release and lock plates, whereby the slide lock mechanism functions based on movement of the button, the button has two positions, a first operating position and a second non-operating position, when the button is in a non-operating position the rollers are urged against the angled locking surface of the cutouts thereby wedging the rollers against the sidewalls of the recess preventing the contact element from moving towards the handle.

In another further embodiment, the mechanism further comprises a tool having a body with at least one recess and a head with at least one opening and at least one handle.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a perspective view of one of the embodiments of the present invention;

FIG. 2 is an exploded view of FIG. 1 showing the internal workings of the gears;

FIG. 3 is a detailed view of rollers in FIG. 2; and

FIGS. 4, 4a-b are detailed views of another embodiment of the present invention.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

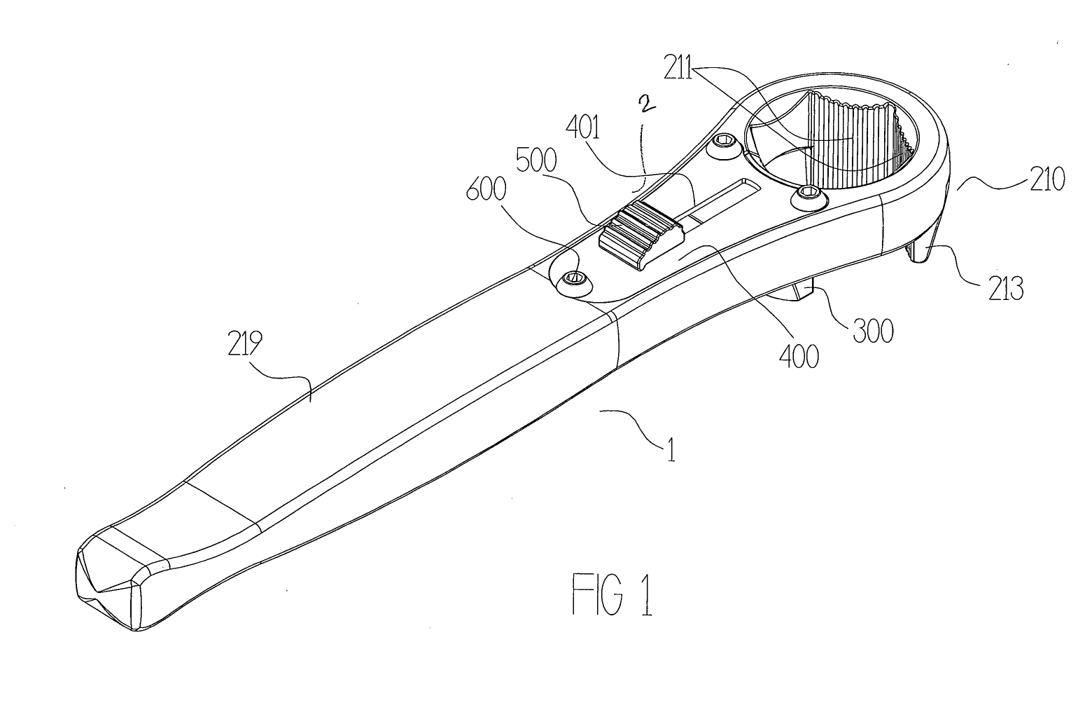

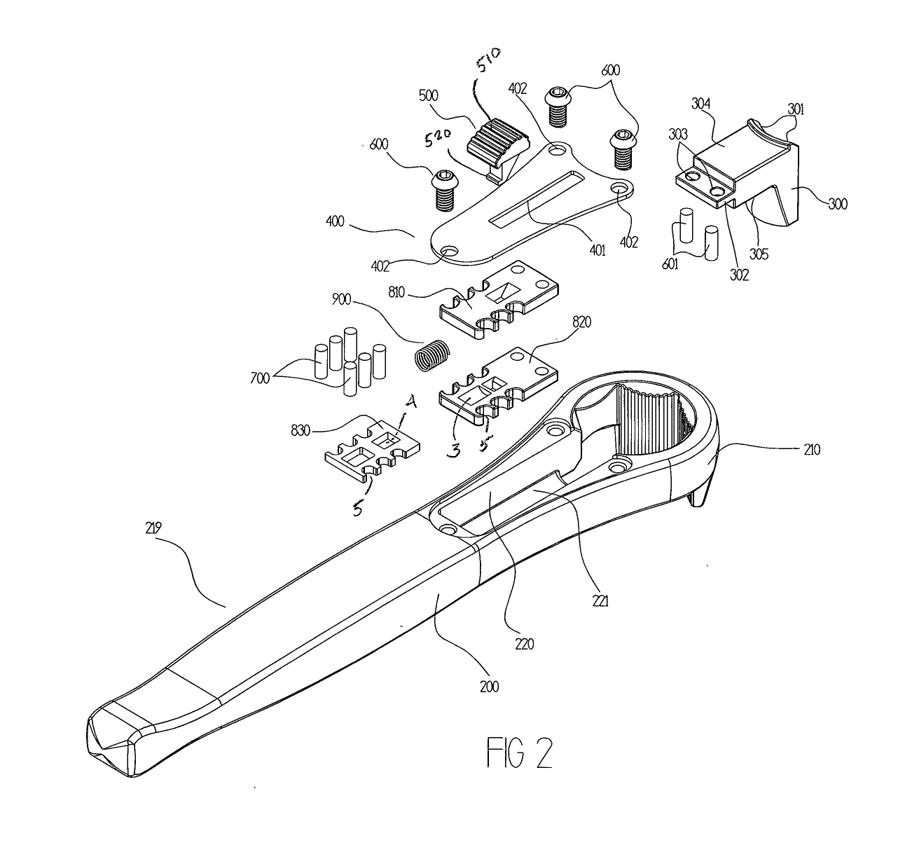

FIGS. 1-4a-b show one embodiment of the present invention, in particular, a wrench 1 comprising: an elongated body 219 having opposing ends, the first end comprises a head 210 with an opening and the second end forming a handle 200, and the body 219 comprising a recess 221 situated adjacent the head 210. The recess 221 having at least one back surface and at least two opposing walls 220; and a slide lock mechanism 2 comprising two lock plate 210 and 820, one release plate 830 and rollers 700. Each of the lock and release plates comprising at least on spring holding compartment 3, at least one central opening 4 and at least two cutouts 5, each cutout consists of an opening, side walls, and an angled locking surface.

The mechanism 2 has a contact element 300, at least a portion of the contact element 300 contacting at least a portion of the lock plate 210, and the lock plate 210 is situated above the release plate 830 and the openings and cutouts of each of the plates are aligned with one another and inserted with the recess 221 of the body 219. The mechanism 2 further comprises at least two rollers 700 and at least one spring 900, at least a portion of each of the rollers 700 are situated within the cutouts 5 of the plates, at least a portion of the spring 900 is situated within the spring holding compartment 3 of the plates, and the spring 900 causes the rollers 700 to engage the opposing walls of the recess 221 of the body 219.

The mechanism 2 further comprises at least one button 500 having a top contact surface 510 and a bottom protrusion 520, at least a portion of the protrusion 520 is designed to be situated within the central openings of the release and lock plates, whereby the slide lock mechanism 2 functions based on movement of the button 500, and the button 500 has two positions, a first operating position and a second non-operating position, when the button 500 is in a non-operating position the rollers 700 are urged against the angled locking surface of the cutouts 5 thereby wedging the rollers 700 against the sidewalls of the recess 221 preventing the contact element 300 from moving towards the handle 200.

The button 500 is moved toward the head 210 thereby allowing movement of the contact element 300 to move upwards within the opening of the head 210 and change the width of the opening on the head 210 and wherein the button 500 is moved toward the handle 200 thereby allowing the rollers 700 to reduce locking contact with the opposing walls of the recess 221 of the body 219 and reduce locking contact with angled locking surface of the cutouts 5 thereby allowing the contact element 300 to adjust the width of the opening on the head 210.

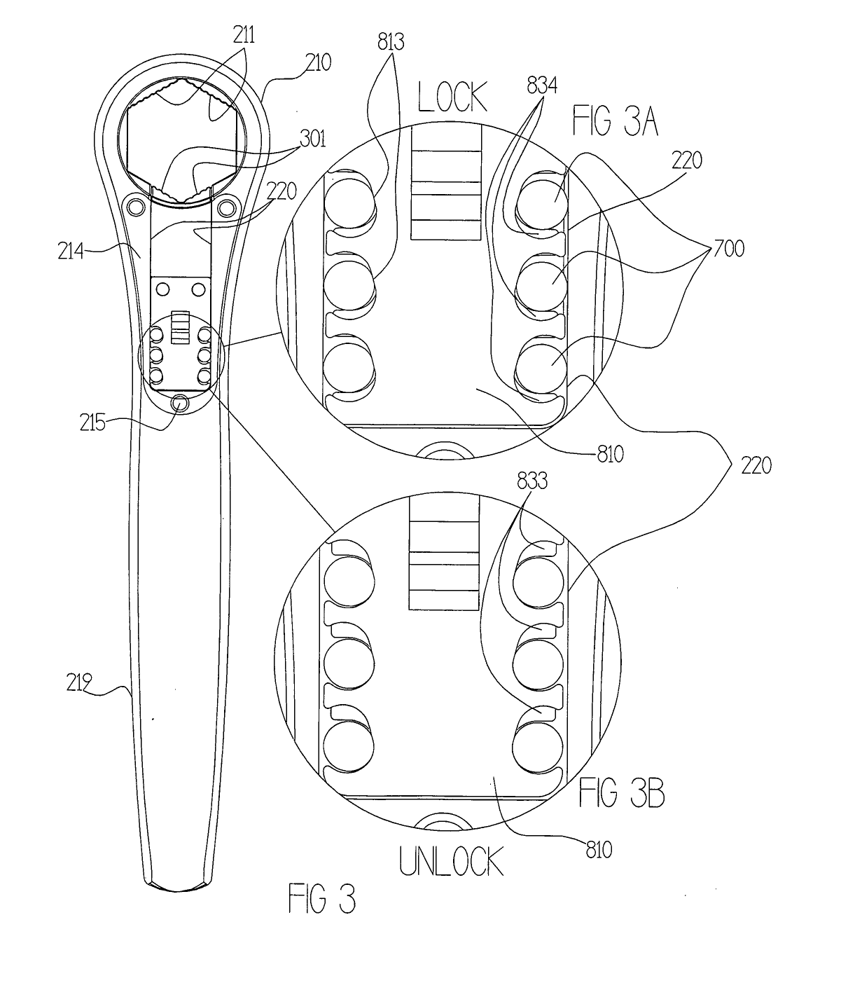

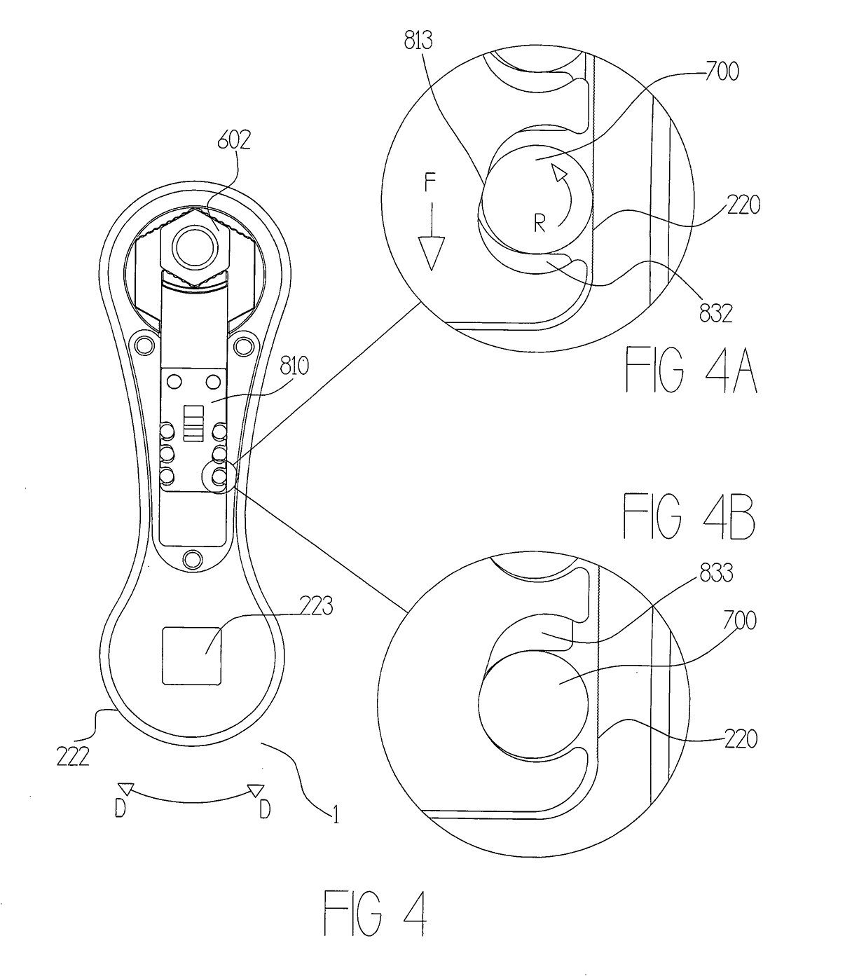

As shown in FIGS. 3-4a-b, the movement of the button 500 towards the head 210 decreases the width of the opening on the head 210; and the movement of the button 500 towards the handle 200 increases the width of the opening on the head 210.

The wrench 1 further comprises at least one face plate 402, and the face plate 402 has a slit 401 designed to receive a portion of the button 500, and the face plate 402 designed to cover the recess 221 of said body 219.

The mechanism including, but limited to the device for moving the movable element and the pivoting mechanism can be used and interchanged to form various embodiments of the present invention. Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A wrench comprising:
an elongated body having opposing ends, said first end comprising a head with an opening and said second end forming a handle, said body comprising a recess situated adjacent said head, said recess having at least one back surface and at least two opposing walls; and
a slide lock mechanism comprising at least one lock plate, at least one release plate and at least two rollers, each of said lock and release plates comprising at least on spring holding compartment, at least one central opening and at least two cutouts, each cutout consists of an opening, side walls, and an angled locking surface, said mechanism having a contact element, at least a portion of said contact element contacting at least a portion of said lock plate, said lock plate is situated above said release plate and said openings and cutouts of each of said plates are aligned with one another and inserted with the recess of said body, said mechanism further comprising at least two rollers and at least one spring, at least a portion of each of said rollers are situated within said cutouts of said plates, at least a portion of said spring is situated within said spring holding compartment of said plates, said spring causes said rollers to engage said opposing walls of said recess of said body, said mechanism further comprises at least one button having a top contact surface and a bottom protrusion, at least a portion of said protrusion is designed to be situated within said central openings of said release and lock plates, whereby said slide lock mechanism functions based on movement of said button, said button has two positions, a first operating position and a second non-operating position, when said button is in a non-operating position said rollers are urged against said angled locking surface of said cutouts thereby wedging said rollers against said sidewalls of said recess preventing the contact element from moving towards the handle.

2. The wrench of claim 1 wherein said button is moved toward said head thereby allowing movement of said contact element to move upwards within said opening of said head and change the width of said opening on said head and wherein said button is moved toward said handle thereby allowing said rollers to reduce locking contact with said opposing walls of said recess of said body and reduce locking contact with angled locking surface of said cutouts thereby allowing said contact element to adjust the width of said opening on said head.

3. The wrench of claim 1 wherein said movement of said button towards said head decreases the width of said opening on said head.

4. The wrench of claim 1 wherein said movement of said button towards said handle increases the width of said opening on said head.

5. The wrench of claim 1 further comprising at least one face plate, said face plate having a slit designed to receive a portion of said button, said face plate designed to cover said recess of said body.

6. The wrench of claim 1 wherein said protrusion of said button is wedge shaped.

7. The wrench of claim 1 further comprising a second lock plate, said second lock plate comprising at least on spring holding compartment, at least one central opening and at least two cutouts.

8. The wrench of claim 7 wherein said second lock plate is situated below said release plate and said spring holding compartments, said central opening and said cutouts are aligned relative to said two lock plates and said release plate.

9. The wrench of claim 8 wherein said release plate is sandwiched between said two lock plates.

10. The wrench of claim 1 wherein said opposing walls having an enhanced gripping surface.

11. The wrench of claim 1, wherein said back surface of said recess is formed by a second cover plate.

12. The wrench of claim 1, wherein said angled locking surface of said cutouts has an enhanced gripping surface.

13. The wrench of claim 1, wherein said sidewalls of said recess are made of an insert of hardened metal.

14. A slide lock mechanism designed to work with a tool, said tool comprising a body with a recess and a head with an opening and a handle, said mechanism comprising:
at least one lock plate, at least one release plate and at least two rollers, each of said lock and release plates comprising at least one spring holding compartment, at least one central opening and at least two cutouts, said mechanism having a contact element, at least a portion of said contact element contacting a portion of said lock plate, said lock plate is situated above said release plate and said openings and cutouts of each of said plates are aligned with one another and inserted with the recess of said body, said mechanism further comprising at least two rollers and at least one spring, at least a portion of each of said rollers are situated within said cutouts of said plates, at least a portion of said spring is situated within said spring holding compartment of said plates, said spring causes said rollers to engage said opposing walls of said recess of said body, said mechanism further comprises at least one button having a top contact surface and a bottom protrusion, at least a portion of said protrusion is designed to be situated within said central openings of said release and lock plates, whereby said slide lock mechanism functions based on movement of said button, said button has two positions, a first operating position and a second non-operating position, when said button is in a non-operating position said rollers are urged against said angled locking surface of said cutouts thereby wedging said rollers against said sidewalls of said recess preventing the contact element from moving towards the handle.

12. The wrench of claim 11 wherein said button is moved toward said head thereby allowing movement of said contact element to move upwards within said opening of said head and change the width of said opening on said head and wherein said button is moved toward said handle thereby allowing said rollers to reduce locking contact with said opposing walls of said recess of said body and reduce locking contact with angled locking surface of said cutouts thereby allowing said contact element to adjust the width of said opening on said head.

13. The wrench of claim 11 further comprising a second lock plate, said second lock plate comprising at least one spring holding compartment, at least one central opening and at least two cutouts.

14. The wrench of claim 13 wherein said second lock plate is situated below said release plate and said spring holding compartments, said central opening and said cutouts are aligned relative to said two lock plates and said release plate.

15. The wrench of claim 14 wherein said release is sandwiched between said two lock plates.

16. A slide lock mechanism designed to work with a tool, said tool comprising a body with a recess and a head with an opening and a handle, said mechanism comprising:
at least one lock plate, at least one release plate and at least two rollers, each of said lock and release plates comprising at least one spring holding compartment, at least one central opening and at least two cutouts, said lock plate having a contact element, said lock plate is situated above said release plate and said openings and cutouts of each of said plates are aligned with one another and inserted with the recess of said body, said mechanism further comprising at least two rollers and at least one spring, at least a portion of each of said rollers are situated within said cutouts of said plates, at least a portion of said spring is situated within said spring holding compartment of said plates, said spring causes said rollers to engage said opposing walls of said recess of said body, said mechanism further comprises at least one button having a top contact surface and a bottom protrusion, at least a portion of said protrusion is designed to be situated within said central openings of said release and lock plates, whereby said slide lock mechanism functions based on movement of said button, said button has two positions, a first operating position and a second non-operating position, when said button is in a non-operating position said rollers are urged against said angled locking surface of said cutouts thereby wedging said rollers against said sidewalls of said recess preventing the contact element from moving towards the handle.

17. The mechanism of claim 16 further comprising a tool.

18. The mechanism of claim 17 wherein said tool comprises a body having at least one recess.

19. The mechanism of claim 18 wherein said tool further comprises a head with at least one opening.

20. The mechanism of claim 19 wherein said tool further comprises at least one handle.
